(19) United States
(12) Patent Application Publication
(10) Pub. No.: US 2024/0414345 A1
(43) Pub. Date: Dec. 12, 2024

(54) IMAGE COMPRESSION METHOD, IMAGE DECOMPRESSION METHOD, AND DEVICE

(71) Applicant: Shanghai SenseTime Intelligent Technology Co., Ltd., Shanghai (CN)

(72) Inventors: Dailan HE, Shanghai (CN); Ziming YANG, Shanghai (CN); Yan WANG, Shanghai (CN); Hongwei QIN, Shanghai (CN)

(21) Appl. No.: 18/812,353

(22) Filed: Aug. 22, 2024

Related U.S. Application Data
(63) Continuation of application No. PCT/CN2022/100500, filed on Jun. 22, 2022.

(30) Foreign Application Priority Data
Feb. 22, 2022 (CN) 202210163126.5

(51) Int. Cl. H04N 19/13; H04N 19/124; H04N 19/136; H04N 19/42

(52) U.S. Cl. CPC H04N 19/13; H04N 19/124; H04N 19/136; H04N 19/42

(57) ABSTRACT

An image compression method comprises: performing feature extraction on the target image to obtain a first feature map comprising a plurality of channels; grouping the channels of the first feature map to obtain a plurality of second feature maps; performing spatial context feature extraction on the second feature maps to determine first spatial redundancy features corresponding to the second feature maps; and performing channel context feature extraction on the second feature maps to determine first channel redundancy features corresponding to the second feature maps; determining compression information corresponding to each of the second feature maps based on a first spatial redundancy feature and a first channel redundancy feature corresponding to each of the second feature maps and thus determining first compressed data corresponding to the target image, and performing deep compression processing based on the first feature map to determine second compressed data corresponding to the target image.

The present application is a bypass continuation of International Patent Application No. PCT/CN2022/100500 filed on Jun. 22, 2022, which is based upon and claims the benefit of priority of Chinese Patent Application No. 202210163126.5, entitled “IMAGE COMPRESSION METHOD, IMAGE DECOMPRESSION METHOD, AND DEVICES” and filed with the Chinese Patent Office on Feb. 22, 2022, the entire contents of all of which are incorporated herein by reference.

### TECHNICAL FIELD

The present disclosure relates to the technical field of image processing, and specifically relates to an image compression method, an image decompression method, and a device.

### BACKGROUND

Image compression is a technique of representing the original pixel matrix with fewer bits in a lossy or lossless manner, also referred to as image encoding. The reason why image data can be compressed is that there are redundancies in the data. The redundancy in image data is manifested as, e.g., a spatial redundancy caused by the correlation between adjacent pixels in the image. The image compression aims to reduce the number of bits required to represent image data by removing these redundancies.

### SUMMARY

According to the embodiments of the present disclosure, there are provided at least an image compression method, an image decompression method, and a device.

According to one aspect of the present disclosure, there is provided an image compression method according to an embodiment of the present disclosure, comprising:
acquiring a target image, and performing feature extraction on the target image to obtain a first feature map comprising a plurality of channels;
grouping the channels of the first feature map to obtain a plurality of second feature maps;
performing spatial context feature extraction on the second feature maps to determine first spatial redundancy features corresponding to the second feature maps;
performing channel context feature extraction on the second feature maps to determine first channel redundancy features corresponding to the second feature maps;
determining compression information corresponding to each of the second feature maps respectively based on a first spatial redundancy feature and a first channel redundancy feature corresponding to each of the second feature maps; and
determining first compressed data corresponding to the target image based on the compression information corresponding to each of the second feature maps, and performing deep compression processing on the first feature map to determine second compressed data corresponding to the target image, the first compressed data and the second compressed data constituting a target compression result corresponding to the target image.

Thus, by grouping the channels of the first feature map obtained after performing the feature extraction to obtain a plurality of second feature maps, and by performing the spatial context feature extraction and channel context feature extraction on the second feature maps, the second feature maps may be subjected to both the spatial redundancy compression and channel redundancy compression, thereby improving the compression encoding rate of the target image. Thereafter, the image is compressed based on the first spatial redundancy feature and the first channel redundancy feature, and thus the size of the target compression result corresponding to the target image is reduced.

In a possible implementation, after obtaining the first feature map, the method further comprises: performing quantization on the first feature map; and
wherein grouping the channels of the first feature map to obtain the plurality of the second feature maps comprises: grouping the channels of the first feature map that has been quantized based on the predetermined number of a plurality of target channels to obtain a plurality of predetermined groupings, and channel values of each predetermined grouping respectively constitute a second feature map; wherein the number of channels included in each of the second feature maps are not identical. Thus, by grouping the first feature map non-uniformly based on the number of target channels, the semantic information of the target image included in each second feature map after been grouped is similar, thereby improving the encoding compression rate of the target image. Besides, compared with uniform grouping of the first feature map, the non-uniform grouping allows for fewer groupings, such that the computing speed in the subsequent grouping operation may be increased, thereby improving the efficiency in compressing the target image.

In a possible implementation, performing the spatial context feature extraction on the second feature maps to determine the first spatial redundancy features corresponding to the second feature maps comprises: for any one of the second feature maps, determining a first spatial redundancy feature corresponding to each of the channels of the second feature map respectively in turn based on a spatial context model; the first spatial redundancy feature corresponding to each of the channels of the second feature map constituting the first spatial redundancy feature corresponding to the second feature map.

In a possible implementation, the method further comprises determining a first spatial redundancy feature corresponding to each of the channels of the second feature map by the following method: for any one channel of any one of the second feature maps, inputting a channel value of a channel preceding the present channel into the spatial context model to determine a first spatial redundancy feature corresponding to the present channel; and a first spatial redundancy feature corresponding to a first channel of any one of the second feature maps being null. Thus, by inputting the channel value of the channel preceding the present channel into the spatial context model, the spatial redundancies of the present channel and each previous channel may be determined, thereby enabling better image compression and improving the encoding compression rate of the image.

In a possible implementation, performing the channel context feature extraction on the second feature maps to determine the first channel redundancy features corresponding to the second feature maps comprises: for an (N+1)th second feature map, inputting previous N second feature maps into a channel autoregressive model to determine a first channel redundancy feature corresponding to the (N+1)th second feature map; wherein N is a positive integer, a first channel redundancy feature of a first second feature map is null, and a channel number of each channel of the (N+1)th second feature map in the first feature map is greater than the channel numbers of the previous N second feature maps. Thus, by inputting the second feature maps preceding the present second feature map into the channel autoregressive model, the channel redundancies of the present second feature map and each of the previous second feature maps may be determined, thereby enabling better image compression and improving the encoding compression rate of the image.

In a possible implementation, determining the compression information corresponding to each of the second feature maps respectively based on the first spatial redundancy feature and the first channel redundancy feature corresponding to each of the second feature maps comprises: determining an encoding probability feature corresponding to the target image; and for any one of the second feature maps, determining the compression information corresponding to the second feature map based on the first spatial redundancy feature and the first channel redundancy feature corresponding to the second feature map, and the encoding probability feature. Thus, since the encoding probability feature can assist the target image in performing the entropy encoding, the encoding compression rate of the target image may be further improved by adding the encoding probability feature to the compression information corresponding to the target image.

In a possible implementation, determining the encoding probability feature corresponding to the target image comprises: encoding the first feature map based on a priori encoder to obtain a third feature map corresponding to the target image; and performing quantization on the third feature map, and decoding the quantized third feature map based on a priori decoder to obtain the encoding probability feature.

In a possible implementation, performing the deep compression processing based on the first feature map to determine the second compressed data corresponding to the target image comprises: inputting, after obtaining the quantized third feature map based on the first feature map, the quantized third feature map into a first entropy encoding model to obtain second compressed data output by the first entropy encoding model. Thus, by inputting the quantized third feature map into the entropy encoding model to obtain the second compressed data, thus it is possible to obtain the encoding probability feature for assisting image decompression by performing decompression processing on the second compressed data during the image decompression.

In a possible implementation, for any one of the second feature maps, determining the compression information corresponding to the second feature map based on the first spatial redundancy feature and the first channel redundancy feature corresponding to the second feature map and the encoding probability feature comprises: splicing the first spatial redundancy feature, the first channel redundancy feature, and the encoding probability feature to obtain a spliced target tensor; and performing feature extraction on the target tensor based on a parameter generation network to generate the compression information corresponding to the second feature map. Thus, by splicing the first spatial redundancy feature, the first channel redundancy feature, and the encoding probability feature, and by performing the feature extraction on the target tensor obtained after the splicing based on the parameter generation network, the obtained compression information corresponding to the second feature map includes the compression information of the target image in a plurality of dimensions, so that the compression encoding rate of the target image may be improved.

In a possible implementation, determining the first compressed data corresponding to the target image based on the compression information corresponding to each of the second feature maps comprises: inputting the first feature map and the compression information corresponding to each of the second feature maps into a second entropy encoding model to obtain the first compressed data output by the second entropy encoding model.

According to one aspect of the present disclosure, there is provided an image decompression method according to an embodiment of the present disclosure, comprising: acquiring a target compression result that is compressed based on any one of the methods; and decoding the target compression result to obtain a target image.

In a possible implementation, decoding the target compression result to obtain the target image comprises: performing first decoding on the target compression result to obtain a plurality of second feature maps; splicing channels of the plurality of the second feature maps to obtain a first feature map; and performing second decoding on the first feature map to obtain the target image.

In a possible implementation, performing the first decoding on the target compression result to obtain the plurality of the second feature maps comprises: decoding second compressed data in the target compression result to obtain an encoding probability feature corresponding to the target image; for an (M+1)th channel to be decompressed, performing spatial context feature extraction and channel context feature extraction on values of previous M channels that have been decompressed to determine compression information corresponding to the (M+1)th channel, wherein the compression information of a first channel is determined based on the encoding probability feature; and decoding first compressed data in the target compression result based on the compression information corresponding to the (M+1)th channel to determine a value of the (M+1)th channel, wherein the values of the channels belonging to a same predetermined grouping constitute one second feature map.

In a possible implementation, decoding the second compressed data in the target compression result to obtain the encoding probability feature corresponding to the target image comprises: inputting the second compressed data into a first entropy decoding model to obtain a fourth feature map output by the first entropy decoding model; and decoding the fourth feature map to obtain the encoding probability feature.

In a possible implementation, the (M+1)th channel belongs to a K-th predetermined grouping, wherein K is a positive integer; and for the (M+1)th channel to be decompressed, performing the spatial context feature extraction and the channel context feature extraction on the values of the previous M channels that have been decompressed to determine the compression information corresponding to the (M+1)th channel comprises: performing spatial context feature extraction on values of channels with channel numbers less than M+1 in the K-th predetermined grouping to determine a second spatial redundancy feature corresponding to the (M+1)th channel; and performing channel context feature extraction on second feature maps corresponding to previous K−1 predetermined groupings to determine a second channel redundancy feature corresponding to the (M+1)th channel; and determining the compression information corresponding to the (M+1)th channel based on the second spatial redundancy feature, the second channel redundancy feature, and the encoding probability feature.

In a possible implementation, decoding the first compressed data in the target compression result based on the compression information corresponding to the (M+1)th channel to determine the value of the (M+1)th channel comprises: inputting the compression information corresponding to the (M+1)th channel and the first compressed data into a second entropy decoding model to determine the value of the (M+1)th channel.

According to one aspect of the present disclosure, there is further provided an image compression device according to an embodiment of the present disclosure, comprising:
an acquiring module configured to: acquire a target image, and perform feature extraction on the target image to obtain a first feature map comprising a plurality of channels;
a grouping module configured to group the channels of the first feature map to obtain a plurality of second feature maps;
a feature extraction module configured to: perform spatial context feature extraction on the second feature maps to determine first spatial redundancy features corresponding to the second feature maps, and perform channel context feature extraction on the second feature maps to determine first channel redundancy features corresponding to the second feature maps;
a first determining module configured to determine compression information corresponding to each of the second feature maps respectively based on a first spatial redundancy feature and a first channel redundancy feature corresponding to each of the second feature maps; and a second determining module configured to: determine first compressed data corresponding to the target image based on the compression information corresponding to each of the second feature maps, and perform deep compression processing based on the first feature map to determine second compressed data corresponding to the target image, wherein the first compressed data and the second compressed data constitute a target compression result corresponding to the target image.

In a possible implementation, the acquiring module is further configured to, after obtaining the first feature map, perform quantization on the first feature map; and the grouping module, in grouping the channels of the first feature map to obtain a plurality of second feature maps, is configured to: group the channels of the first feature map that has been quantized based on the predetermined number of a plurality of target channels to obtain a plurality of predetermined groupings, wherein channel values of one predetermined grouping constitute one second feature map, and the number of channels included in each of the second feature maps are not identical.

In a possible implementation, the feature extraction module, in response to performing the spatial context feature extraction on the second feature maps to determine the first spatial redundancy features corresponding to the second feature maps, is configured to: for any one of the second feature maps, determine a first spatial redundancy feature corresponding to each of the channels of the second feature map respectively in turn based on a spatial context model, wherein the first spatial redundancy feature corresponding to each of the channels of the second feature map constitute the first spatial redundancy feature corresponding to the second feature map.

In a possible implementation, the feature extraction module is further configured to determine the first spatial redundancy features corresponding to the channels of the second feature map by the following step: for any one of the channels of any one of the second feature maps, input a channel value of a channel preceding the present channel into the spatial context model to determine a first spatial redundancy feature corresponding to the present channel, wherein a first spatial redundancy feature corresponding to the first channel of any one of the second feature maps is null.

In a possible implementation, the feature extraction module, in response to performing the channel context feature extraction on the second feature maps to determine the first channel redundancy features corresponding to the second feature maps, is configured to: for an (N+1)th second feature map, input previous N second feature maps into a channel autoregressive model to determine a first channel redundancy feature corresponding to the (N+1)th second feature map, wherein N is a positive integer, a first channel redundancy feature of the first second feature map is null, and a channel number of the channel of the (N+1)th second feature map in the first feature map is greater than the channel number of the previous N second feature maps.

In a possible implementation, the first determining module, in response to determining compression information corresponding to each of the second feature maps respectively based on the first spatial redundancy feature and the first channel redundancy feature corresponding to each of the second feature maps, is configured to: determine an encoding probability feature corresponding to the target image, and for any one of the second feature maps, determine the compression information corresponding to the second feature map based on the first spatial redundancy feature and the first channel redundancy feature corresponding to the second feature map and the encoding probability feature.

In a possible implementation, the first determining module, in response to determining the encoding probability feature corresponding to the target image, is configured to: encode the first feature map based on a priori encoder to obtain a third feature map corresponding to the target image, perform quantization on the third feature map, and decode the third feature map that has been quantized based on a priori decoder to obtain the encoding probability feature.

In a possible implementation, the second determining module, in response to performing the deep compression processing based on the first feature map to determine the second compressed data corresponding to the target image, is configured to: input, after obtaining the quantized third feature map based on the first feature map, the quantized third feature map into a first entropy encoding model to obtain second compressed data output by the first entropy encoding model.

In a possible implementation, the first determining module, when in response to any one of the second feature maps, determining the compression information corresponding to the second feature map based on the first spatial redundancy feature and the first channel redundancy feature corresponding to the second feature map and the encoding probability feature, is configured to: splice the first spatial redundancy feature, the first channel redundancy feature, and the encoding probability feature to obtain a spliced target tensor, and perform feature extraction on the target tensor based on a parameter generation network to generate the compression information corresponding to the second feature map.

In a possible implementation, the second determining module, in response to determining the first compressed data corresponding to the target image based on the compression information corresponding to each of the second feature maps, is configured to: input the first feature map and the compression information corresponding to each of the second feature maps to a second entropy encoding model to obtain first compressed data output by the second entropy encoding model.

According to one aspect of the present disclosure, an embodiment of the present disclosure further provides an image decompression device, comprising: a second acquiring module configured to acquire a target compression result that is compressed based on any one of the methods; and a decoding module configured to decode the target compression result to obtain a target image.

In a possible implementation, the decoding module, in response to decoding the target compression result to obtain the target image, is configured to: perform first decoding on the target compression result to obtain a plurality of second feature maps; splice channels of the plurality of the second feature maps to obtain a first feature map; and perform second decoding on the first feature map to obtain the target image.

In a possible implementation, the decoding module, in response to performing first decoding on the target compression result to obtain the plurality of second feature maps, is configured to: decode second compressed data in the target compression result to obtain an encoding probability feature corresponding to the target image; for an (M+1)th channel to be decompressed, perform spatial context feature extraction and channel context feature extraction on values of previous M channels that have been decompressed to determine compression information corresponding to the (M+1)th channel, wherein the compression information of the first channel is determined based on the encoding probability feature; and decode first compressed data in the target compression result based on the compression information corresponding to the (M+1)th channel to determine a value of the (M+1)th channel, wherein the values of the channels belonging to a same predetermined grouping constitute one second feature map.

In a possible implementation, the decoding module, in response to decoding second compressed data in the target compression result to obtain the encoding probability feature corresponding to the target image, is configured to: input the second compressed data into a first entropy decoding model to obtain a fourth feature map output by the first entropy decoding model, and decode the fourth feature map to obtain the encoding probability feature.

In a possible implementation, the (M+1)th channel belongs to a K-th predetermined grouping, wherein K is a positive integer; the decoding module, when in response to the (M+1)th channel to be decompressed, performing the spatial context feature extraction and the channel context feature extraction on the values of the first M channels that have been decompressed to determine the compression information corresponding to the (M+1)th channel, is configured to: perform spatial context feature extraction on values of channels with channel numbers less than M+1 in the K-th predetermined grouping to determine a second spatial redundancy feature corresponding to the (M+1)th channel; perform channel context feature extraction on the second feature maps corresponding to previous (K−1)th predetermined groupings to determine a second channel redundancy feature corresponding to the (M+1)th channel; and determine the compression information corresponding to the (M+1)th channel based on second spatial redundancy feature, the second channel redundancy feature, and the encoding probability feature.

In a possible implementation, the decoding module, in response to decoding the first compressed data in the target compression result based on the compression information corresponding to the (M+1)th channel to determine the value of the (M+1)th channel, is configured to: input the compression information corresponding to the (M+1)th channel and the first compressed data into a second entropy decoding model to determine the value of the (M+1)th channel.

According to one aspect of the present disclosure, there is further provided a computer apparatus according to an embodiment of the present disclosure, comprising: a processor, a memory, and a bus, wherein the memory stores machine readable instructions executable by the processor, when the computer apparatus runs, the processor communicates with the memory via the bus, and the machine readable instructions, when executed by the processor, cause steps in any one of possible implementations described above to be executed.

According to one aspect of the present disclosure, there is further provided a computer readable storage medium having a computer program stored thereon, wherein the computer program, when executed by a processor, causes steps in any one of possible implementations described above to be executed.

According to one aspect of the present disclosure, there is provided a computer program product, comprising computer readable codes, or a non-transitory computer readable storage medium hosting the computer readable codes, wherein when the computer readable codes run in a processor of an electronic apparatus, the processor of the electronic apparatus executes the methods described above.

Descriptions of the above image compression method may be referred to for the effect descriptions of the above image decompression method, image decompression device, image compression device, computer apparatus, and computer readable storage medium, which will not be repeated here.

To render the above purposes, features, and advantages of the present disclosure more apparent and lucid, preferred embodiments are particularly enumerated and described in detail below with reference to the attached drawings.

### BRIEF DESCRIPTION OF THE DRAWINGS

For the sake of illustrating the technical solutions of the embodiments of the present disclosure more clearly, the drawings used in the embodiments are briefly described below, which are incorporated in and constitute part of the specification, show the embodiments appropriate for the present disclosure, and are used to explain the technical solutions of the present disclosure together with the specification. It should be understood that the drawings below show only some of the embodiments of the present disclosure and thus shall not be construed as a limitation on the scope. For a person skilled in the art, other related drawings may further be obtained from these drawings without affording any creative effort.

FIG. 1 shows a flowchart of an image compression method provided in an embodiment of the present disclosure.

FIG. 2a shows a schematic diagram of a network structure of a channel autoregressive model in an image compression method provided in an embodiment of the present disclosure.

FIG. 2b shows a schematic diagram of a network structure of a priori decoder in an image compression method provided in an embodiment of the present disclosure.

FIG. 2c shows a schematic diagram of a network structure of a parameter generation network in an image compression method provided in an embodiment of the present disclosure.

FIG. 3 shows a flowchart of a specific method for determining compression information corresponding to each of second feature maps in an image compression method provided in an embodiment of the present disclosure.

FIG. 4 shows a flowchart of a specific method for determining an encoding probability feature corresponding to a target image in an image compression method provided in an embodiment of the present disclosure.

FIG. 5 shows a flowchart of a specific method for determining compression information corresponding to second feature maps in an image compression method provided in an embodiment of the present disclosure.

FIG. 6 shows a flowchart of an image decompression method provided in an embodiment of the present disclosure.

FIG. 7 shows a flowchart of a specific method for obtaining a decompressed target image in an image decompression method provided in an embodiment of the present disclosure.

FIG. 8 shows a flowchart of a specific method for obtaining second feature maps in an image decompression method provided in an embodiment of the present disclosure.

FIG. 9 shows an overall flowchart of an image encoding and decoding method provided in an embodiment of the present disclosure.

FIG. 10 shows a structural diagram of a parallel feature extraction module provided in an embodiment of the present disclosure.

FIG. 11 shows a schematic diagram of the architecture of an image compression device provided in an embodiment of the present disclosure.

FIG. 12 shows a schematic diagram of the architecture of an image decompression device provided in an embodiment of the present disclosure.

FIG. 13 shows a structural diagram of a computer apparatus provided in an embodiment of the present disclosure.

### DETAILED DESCRIPTION

To make the purposes, technical solutions, and advantages of the embodiments of the present disclosure clearer, the technical solutions of the embodiments described herein will be unequivocally and completely described below with reference to the drawings of the embodiments described herein. It is apparent that the embodiments described herein are only a part of rather than all of embodiments of the present disclosure. The components of the embodiments of the present disclosure described and shown in the drawings here may generally be arranged and designed in various configurations. Therefore, the following detailed descriptions of the embodiments of the present disclosure provided in the drawings are not intended to limit the scope sought to be protected by the present disclosure and are only selected embodiments of the present disclosure. All of the other embodiments obtained from the embodiments of the present disclosure by a person skilled in the art without affording any creative efforts fall within the scope sought to be protected by the present disclosure.

It should be noted that similar numerals and letters represent similar items in the following drawings. Thus once an item is defined in a drawing, there is no need to further define and explain it in the subsequent drawings.

The term “and/or” used herein describes only an association relationship, and represents three possible relationships. For example, A and/or B may represent the following three cases: A exists alone, both A and B exist, and B exists alone. Besides, the term “at least one” used herein represents any one of multiple elements or any combination of at least two of multiple elements. For example, at least one of A, B or C may represent any one or more elements selected from the set consisting of A, B, and C.

Studies have shown that the reason why image data can be compressed is that there are redundancies in the data. The redundancy in image data is manifested as, e.g., a spatial redundancy caused by the correlation between adjacent pixels in the image. The image compression is intended to reduce the number of bits required to represent image data by removing these redundancies. Due to the huge volumes of image data, it is very difficult to store, transmit, and process images. Therefore, how to compress images has become an urgent problem to be solved in this field.

In view of the above studies, the present disclosure provides an image compression method, an image decompression method, and devices. By grouping the first feature map obtained after the feature extraction to obtain a plurality of second feature maps and by performing the spatial context feature extraction and channel context feature extraction on the second feature maps, the second feature maps may be subjected to both the spatial redundancy compression and channel redundancy compression, thereby improving the compression encoding rate of the target image. Thereafter, the image is compressed based on the first spatial redundancy features and the first channel redundancy features, which reduces the size of the target compression result corresponding to the target image.

For ease of understanding of this embodiment, an image compression method disclosed in an embodiment of the present disclosure is described in detail in the first place. The executor of the image compression method provided in an embodiment of the present disclosure is generally a computer apparatus with certain computing power. The computer apparatus includes, for example, a terminal apparatus or a server or other processing apparatuses. The terminal apparatus may be a User Equipment (UE), a mobile apparatus, a user terminal, a terminal, a vehicle-mounted apparatus, a wearable apparatus, etc. In some possible implementations, the image compression method may be implemented by means of invoking, by a processor, the computer-readable instructions stored in the memory.

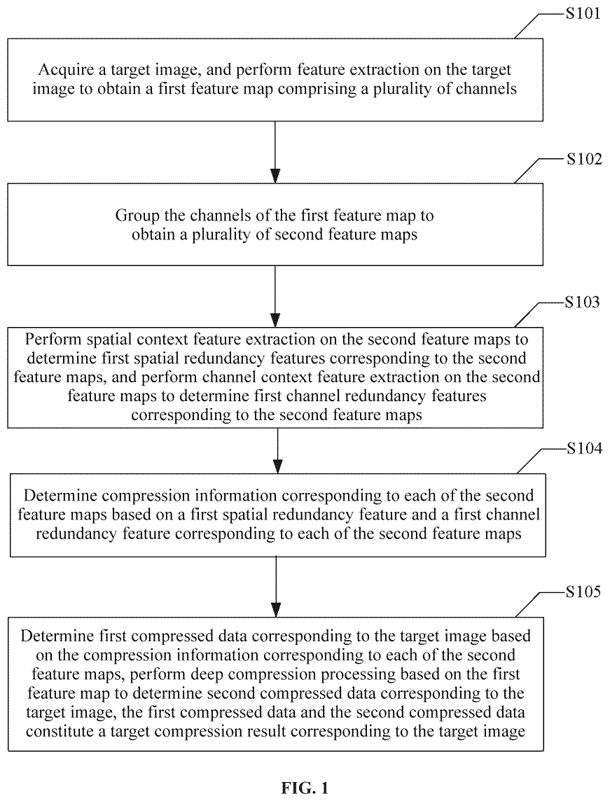

Referring to FIG. 1, there is shown a flowchart of an image compression method provided in an embodiment of the present disclosure. The method comprises steps S101 to S105.

The step S101 includes: acquiring a target image, and performing feature extraction on the target image to obtain a first feature map comprising a plurality of channels.

The step S102 includes: grouping the channels of the first feature map to obtain a plurality of second feature maps.

The step S103 includes: performing spatial context feature extraction on the second feature maps to determine first spatial redundancy features corresponding to the second feature maps; and performing channel context feature extraction on the second feature maps to determine first channel redundancy features corresponding to the second feature maps.

The step S104 includes: determining compression information corresponding to each of the second feature maps respectively based on a first spatial redundancy feature and a first channel redundancy feature corresponding to each of the second feature maps.

The step S105 includes: determining first compressed data corresponding to the target image based on the compression information corresponding to each of the second feature maps, and performing deep compression processing based on the first feature map to determine second compressed data corresponding to the target image, the first compressed data and the second compressed data constituting a target compression result corresponding to the target image.

The following is detailed descriptions of the steps described above.

In step S101, the target image is an image to be compressed. When subjected to feature extraction, the target image may be input into a feature extraction network to obtain a first feature map corresponding to the target image that is output by the feature extraction network. The feature extraction network is a neural network that allows for deep learning, e.g., a convolutional neural network.

Furthermore, after the first feature map is obtained, it may be further quantized, thus corresponding process may be performed subsequently based on the quantized first feature map, to ensure the compression effect of the target image.

In step S102, the channels of the first feature map are grouped to obtain a plurality of second feature maps.

In a possible implementation, when the channels of the first feature map are grouped, the channels of the quantized first feature map may be grouped based on the predetermined number of a plurality of target channels, to obtain a plurality of predetermined groupings, and the channel values of each one of the predetermined groupings constitute one second feature map; wherein the number of channels included in each of the second feature maps are not identical.

Specifically, the semantic information of the target image is often enriched in channels with the channel numbers top-ranked in the first feature map during the feature extraction. Therefore, in order to make the semantic information of the target image included in each of the second feature maps similar to one another to improve the encoding compression rate of the target image, when the channels are grouped from front to back based on the channel numbers in the first feature map, the minimum channel number in the target channel numbers may be determined in turn, and the grouping process may be performed based on the currently minimum channel number. After completion of the grouping, the minimum channel number currently in use may be deleted, and if there is a plurality of identical minimum channel numbers, only one of them is deleted each time. Then the execution is returned to the step of determining the minimum channel number until all of the target channel numbers are deleted. All of the remaining channels, if still present at this time, may be classified into the same grouping to thereby complete the grouping of all channels in the first feature map.

Exemplarily, the channels of the first feature map are channel 1 to channel 640, and the target channel numbers are 16, 16, 32, 64, and 128 in this order. The channels of the first feature map may be divided into 6 groups based on the target channel numbers, and the channel numbering corresponding to each of the groups are channel 1 to channel 16, channel 17 to channel 32, channel 33 to channel 64, channel 65 to channel 128, channel 129 to channel 256, and channel 257 to channel 640 in turn, so as to obtain 6 second feature maps.

Thus, by grouping the first feature map non-uniformly, the semantic information of the target image contained in each of the second feature maps that have been grouped may be similar, thereby improving the encoding compression rate of the target image. Besides, compared with uniform grouping of the first feature map, the non-uniform grouping allows for fewer groupings, such that the computing speed in the subsequent grouping operation may be increased, thereby improving the efficiency in compressing the target image.

In step S103, spatial context feature extraction is performed on the second feature maps to determine first spatial redundancy features corresponding to the second feature maps, and channel context feature extraction is performed on the second feature maps to determine first channel redundancy features corresponding to the second feature maps.

In a possible implementation, for any one of the second feature maps, when determining a first spatial redundancy feature corresponding to this second feature map, a first spatial redundancy feature corresponding to each of the channels of this second feature map may be determined respectively in turn based on the spatial context model; and the first spatial redundancy feature corresponding to each of the channels of this second feature map together constitute the first spatial redundancy feature corresponding to this second feature map.

Here the spatial context model is a neural network that allows for deep learning, e.g., a convolutional neural network.

Exemplarily, the spatial context model is a convolutional neural network. The network structure of the spatial context model may include a convolutional layer, an activation layer, a convolutional layer, an activation layer, and a convolutional layer in turn. A multi-layer convolutional network may allow for better extraction of the first spatial redundancy features of the second feature maps.

Specifically, in response to determining the first spatial redundancy respectively corresponding to each of the channels of any one of the second feature maps, the first spatial redundancy feature corresponding to each of the channels may be determined respectively in sequence from small to large based on the channel numbers of the channels in the second feature map.

In a possible implementation, for any one channel of any one of the second feature maps, when determining the first spatial redundancy feature corresponding to this channel, the channel values of channels preceding this channel may be input into the spatial context model to determine the first spatial redundancy feature corresponding to this channel.

Here the channel values of channels preceding this channel are the values of the channels preceding this channel. The first spatial redundancy feature corresponding to the first channel of any one of the second feature maps is null. The first channel of each of the second feature maps is not necessarily the first channel in the first feature map.

Following on from the above example, if the channels in the 6 second feature maps have the corresponding channel numbering in the first feature map of channel 1 to channel 16, channel 17 to channel 32, channel 33 to channel 64, channel 65 to channel 128, channel 129 to channel 256, and channel 257 to channel 640 in turn, the first channels in the second feature maps have the corresponding channel numbers in the first feature map of channel 1, channel 17, channel 33, channel 65, channel 129, and channel 257 in turn.

Exemplarily, the second feature map A includes 6 channels. In response to determining the first spatial redundancy feature corresponding to the sixth channel in the second feature map A, the channel values respectively corresponding to the first to fifth channels in the second feature map A may be input into the spatial context model to obtain the first spatial redundancy feature corresponding to the sixth channel in the second feature map A that is output by the spatial context model.

Thus, by inputting the channel values of channels preceding one channel to the spatial context model, the spatial redundancies of the channel and the previous channels may be determined, thereby enabling better image compression and improving the encoding compression rate of the image.

In a possible implementation, for the (N+1)th second feature map, when determining the first channel redundancy feature corresponding to this second feature map, the previous N second feature maps may be input into the channel autoregressive model to determine the first channel redundancy feature corresponding to the (N+1)th second feature map.

N is a positive integer. The first channel redundancy feature of the first second feature map is null. The channel number of the channel of the (N+1)th second feature map in the first feature map is greater than the channel numbers of the previous N second feature maps. The channel autoregressive model is a neural network that allows for deep learning, e.g., a convolutional neural network.

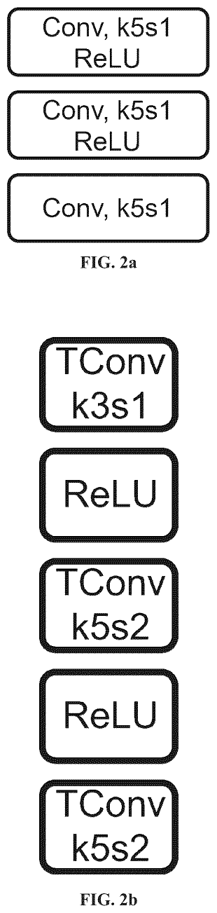

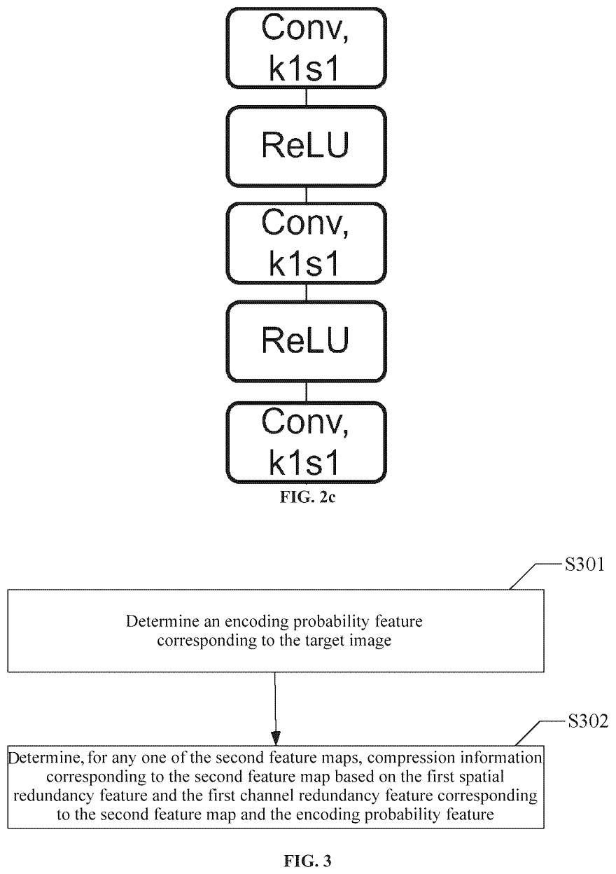

Exemplarily, the channel autoregressive model is a convolutional neural network. The network structure of the channel autoregressive model may be as shown in FIG. 2a. In FIG. 2a, the network structure of the channel autoregressive model includes a convolutional layer, an activation layer, a convolutional layer, an activation layer, and a convolutional layer in turn, where the convolution kernel of each of the convolutional layers is 5×5, the stride is 1, and the activation function corresponding to the activation layer is a ReLU function. A multi-layer convolutional network may allow for better extraction of the first channel redundancy features of the second feature maps.

Specifically, the first channel redundancy features corresponding to the second feature maps may be determined in turn from small to large based on the channel numbers of the channels of the second feature maps in the first feature map, to obtain the first channel redundancy feature corresponding to each of the second feature maps.

Exemplarily, assuming that the channel numbers of the channels in the first to sixth second feature maps in the first feature map are channel 1 to channel 16, channel 17 to channel 32, channel 33 to channel 64, channel 65 to channel 128, channel 129 to channel 256, and channel 257 to channel 640, respectively, in response to determining the first channel redundancy feature corresponding to the fifth feature map, the channel values of the channels in the first to fourth second feature maps (namely, the channel values of channel 1 to channel 128 in the first feature map) may be input into the channel autoregressive model to obtain the first channel redundancy feature corresponding to the fifth second feature map that is output by the channel autoregressive model.

Thus, by inputting the second feature maps preceding one second feature map into the channel autoregressive model, the channel redundancies of the one second feature map and the previous second feature maps may be determined, thereby enabling better image compression and improving the encoding compression rate of the image.

In step S104, compression information corresponding to each of the second feature maps is determined respectively based on a first spatial redundancy feature and a first channel redundancy feature corresponding to each of the second feature maps.

For any one of the second feature maps, the compression information corresponding to the one second feature map is the information to be used for compressing the one second feature map, for example, probability information of compression encoding corresponding to the one second feature map, such as probability information used for arithmetic coding, including at least one of a mean value, a standard deviation, or a variance, or a symbol sequence.

In a possible implementation, as shown in FIG. 3, compression information corresponding to each of the second feature maps may be determined respectively by the following steps S301 and S302.

The step S301 includes: determining an encoding probability feature corresponding to the target image.

Here, the probability encoding feature may include features used for assisting coding, such as low frequency information and local spatial correlation information in the target image. By adding the encoding probability feature to the compression information corresponding to the target image, the encoding compression rate of the target image may be further improved.

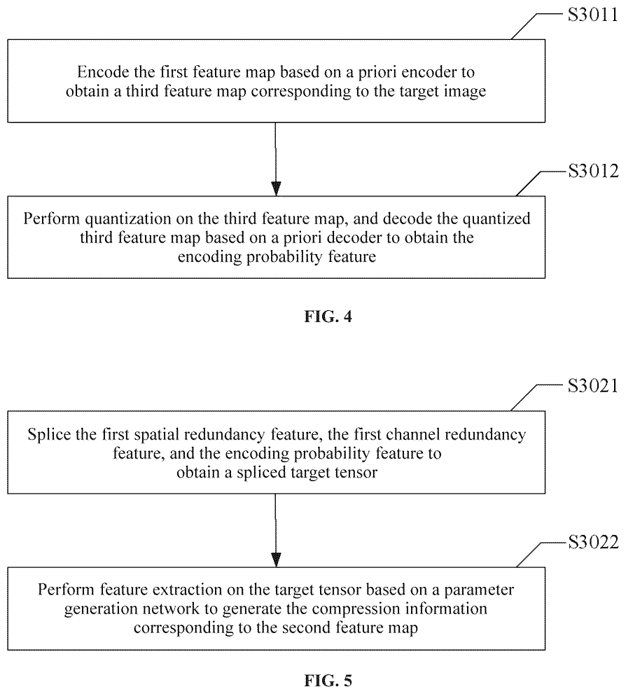

In a possible implementation, as shown in FIG. 4, the encoding probability feature corresponding to the target image may be determined by the following steps S3011 and S3012.

The step S3011 includes: encoding the first feature map based on a priori encoder to obtain a third feature map corresponding to the target image.

Here the priori encoder is a neural network that allows for deep learning, e.g., a convolutional neural network, and is configured to encode the first feature map.

Specifically, in response to encoding the first feature map based on the priori encoder, the first feature map corresponding to the target image may be input into the priori encoder to obtain the third feature map corresponding to the target image that is output by the priori encoder.

The step S3012 includes: performing quantization on the third feature map, and decoding the quantized third feature map based on a priori decoder to obtain the encoding probability feature.

Here the priori decoder is a neural network that allows for deep learning, e.g., a convolutional neural network, and is configured to decode the quantized third feature map.

Exemplarily, the priori decoder is a convolutional neural network. The network structure of the priori decoder may be as shown in FIG. 2b. In FIG. 2b, the network structure of the priori decoder includes a transpose convolutional layer, an activation layer, a transpose convolutional layer, an activation layer, and a transpose convolutional layer in turn, where the convolution kernels of the convolutional layers are 3×3, 5×5, and 5×5 successively, the strides are 1, 2, and 2 successively, and the activation function corresponding to the activation layer is a ReLU function. A multi-layer convolutional network may allow for better decoding of the third feature map.

Specifically, in response to decoding the quantized third feature map based on the priori decoder, the quantized third feature map corresponding to the target image may be input into the priori decoder to obtain the encoding probability feature corresponding to the target image that is output by the priori decoder.

The step S302 includes: for any one of the second feature maps, determining the compression information corresponding to the second feature map based on the first spatial redundancy feature and the first channel redundancy feature corresponding to the second feature map and the encoding probability feature.

Here, for any one of the second feature maps, the compression information corresponding to each of the channels in this second feature map may be determined respectively in turn, and the compression information corresponding to each of the channels together constitute the compression information corresponding to this second feature map.

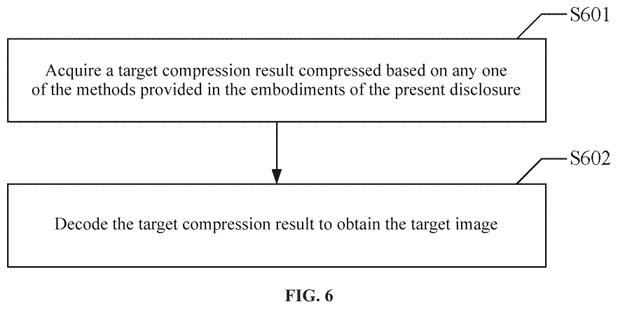

In a possible implementation, as shown in FIG. 5, the compression information corresponding to the second feature maps may be determined by the following steps S3021 and S3022.

The step S3021 includes: splicing the first spatial redundancy feature, the first channel redundancy feature, and the encoding probability feature to obtain a spliced target tensor.

Here, for any one channel of any one of the second feature maps, when splicing the first spatial redundancy feature, first channel redundancy feature, and encoding probability feature, the first spatial redundancy feature corresponding to this channel, the first channel redundancy feature corresponding to the second feature map where this channel is located, and the probability encoding feature may be spliced in a predetermined splicing order to obtain a spliced target tensor.

Thus, since the encoding probability feature can assist the target image in performing the entropy encoding, the encoding compression rate of the target image may be further improved by adding the encoding probability feature to the compression information corresponding to the target image.

The step S3022 includes: performing feature extraction on the target tensor based on a parameter generation network to generate the compression information corresponding to the second feature map.

Here the parameter generation network is a neural network that allows for deep learning, e.g., a convolutional neural network, and is configured to perform feature extraction on a target tensor corresponding to each of the channels in any one of the second feature maps respectively, thereby obtaining the compression information corresponding to each of the channels in this second feature map, and the compression information corresponding to each of the channels together constitute the compression information corresponding to this second feature map.

Exemplarily, assuming that the parameter generation network is a convolutional neural network, and the network structure of the parameter generation network may be as shown in FIG. 2c. In FIG. 2c, the network structure of the parameter generation network includes a convolutional layer, an activation layer, a convolutional layer, an activation layer, and a convolutional layer in turn, where the convolution kernel of each of the convolutional layers is 1×1, the stride is 1, and the activation function corresponding to the activation layer is a ReLU function. A multi-layer convolutional network may allow for better feature extraction of the target tensors, thereby generating the compression information corresponding to the second feature maps.

Thus, by splicing the first spatial redundancy feature, the first channel redundancy feature, and the encoding probability feature, and by performing the feature extraction on the target tensor obtained after the splicing based on the parameter generation network, the obtained compression information corresponding to the second feature maps includes the compression information of the target image in a plurality of dimensions, so that the compression encoding rate of the target image may be improved.

The step S105 includes: determining first compressed data corresponding to the target image based on the compression information corresponding to each of the second feature maps, and performing deep compression processing based on the first feature map to determine second compressed data corresponding to the target image, the first compressed data and the second compressed data together constituting a target compression result corresponding to the target image.

In a possible implementation, in response to determining the first compressed data corresponding to the target image, the first feature map and the compression information corresponding to each of the second feature maps may be input to a second entropy encoding model to obtain the first compressed data output by the second entropy encoding model.

Here the second entropy encoding model may be a probability model in any form, for example, a Gaussian distribution model.

In a possible implementation, in response to determining the second compressed data corresponding to the target image, the quantized third feature map, after being obtained based on the first feature map, may be input into a first entropy encoding model, to obtain the second compressed data output by the first entropy encoding model.

Here the first entropy encoding model may be a probability model in any form, for example, a Gaussian distribution model. Preferably, the first entropy encoding model and the second entropy encoding model may be probability models in the same form, for example, the first entropy encoding model and the second entropy encoding model may both be a Gaussian distribution model.

Thus, by inputting the quantized third feature map into the entropy encoding model to obtain the second compressed data, it is possible to obtain the encoding probability feature for assisting image decompression by performing the decompression processing on the second compressed data during the image decompression.

By grouping the first feature map obtained after performing the feature extraction to obtain a plurality of second feature maps and by performing the spatial context feature extraction and channel context feature extraction on the second feature maps, the image compression method provided in an embodiment of the present disclosure enables it possible to perform both the spatial redundancy compression and channel redundancy compression on the second feature maps, thereby improving the compression encoding rate of the target image. Thereafter, the image is compressed based on the first spatial redundancy features and the first channel redundancy features, which reduces the size of the target compression result corresponding to the target image.

Referring to FIG. 6, there is shown a flowchart of an image decompression method provided in an embodiment of the present disclosure. The method comprises S601 and S602.

The step S601 includes: acquiring a target compression result that is compressed based on any one of the methods provided in the embodiments of the present disclosure.

The step S602 includes: decoding the target compression result to obtain the target image.

The following is detailed description of the steps described above.

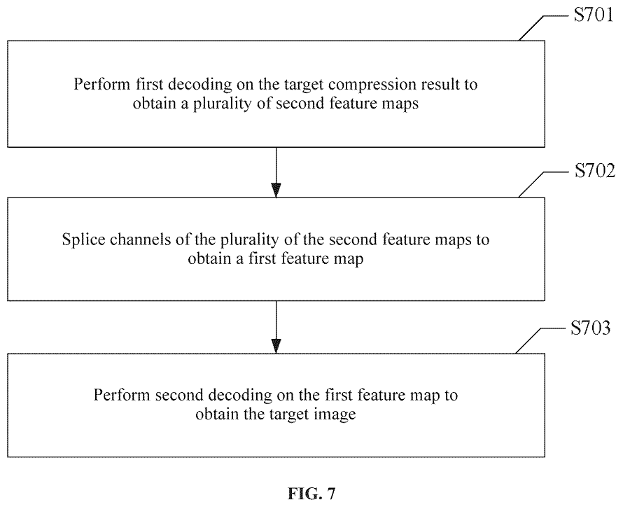

In a possible implementation, as shown in FIG. 7, the decompressed target image may be obtained by the following steps S701 to S703.

The step S701 includes: performing first decoding on the target compression result to obtain a plurality of second feature maps.

Here the target compression result comprises the first compressed data and the second compressed data. The second compressed data is configured to perform compression processing on the first compressed data. Therefore, in response to performing first decompression processing on the target compression result, the first compressed data in the target compression result may be decompressed, and then the second compressed data in the target compression result is decompressed.

In a possible implementation, as shown in FIG. 8, the second feature maps may be obtained by the following steps S7011 to S7013.

The step S7011 includes: decoding second compressed data in the target compression result to obtain an encoding probability feature corresponding to the target image.

In a possible implementation, in response to decoding the second compressed data, the second compressed data is input into a first entropy decoding model to obtain a fourth feature map output by the first entropy decoding model; and the decoding process is performed on the fourth feature map to obtain the encoding probability feature.

Here the first entropy decoding model and the first entropy encoding model may be probability models in the same form, for example, the first entropy encoding model and the first entropy decoding model may both be a Gaussian distribution model. The first entropy decoding model is configured to decode the second compressed data obtained after being processed by the first entropy encoding model, thereby obtaining the fourth feature map.

Specifically, the procedures of decoding the fourth feature map are the same as those of decoding the third feature map as described above. The fourth feature map may be decoded based on the priori decoder to obtain the encoding probability feature.

The step S7012 includes: for an (M+1)th channel to be decompressed, performing spatial context feature extraction and channel context feature extraction on values of previous M channels that have been decompressed to determine compression information corresponding to the (M+1)th channel.

The compression information of the first channel is determined based on the encoding probability feature, and the (M+1)th channel belongs to a K-th predetermined grouping, where K is a positive integer.

In a possible implementation, in response to determining the compression information corresponding to the (M+1)th channel, the spatial context feature extraction is performed on the values of the channels with the channel numbers less than M+1 in the K-th predetermined grouping to determine a second spatial redundancy feature corresponding to the (M+1)th channel. The channel context feature extraction is performed on the second feature maps corresponding to previous (K−1)th predetermined groupings to determine a second channel redundancy feature corresponding to the (M+1)th channel. The compression information corresponding to the (M+1)th channel is determined based on the second spatial redundancy feature, the second channel redundancy feature, and the encoding probability feature.

Here, when performing the spatial context feature extraction in response to the (M+1)th channel, the channel values of the channels with the channel numbers less than M+1 in the K-th predetermined grouping may be input into the spatial context model to obtain the second spatial redundancy feature corresponding to the (M+1)th channel that is output by the spatial context model; when performing the channel context feature extraction, the second feature maps corresponding to previous (K−1)th predetermined groupings may be input into the channel autoregressive model to obtain the second channel redundancy feature corresponding to the (M+1)th channel that is output by the channel autoregressive model.

Specifically, in response to determining the compression information corresponding to the (M+1)th channel, the second spatial redundancy feature, the second channel redundancy feature, and the encoding probability feature may be spliced to obtain a spliced target tensor corresponding to the (M+1)th channel; and feature extraction is performed on the target tensor corresponding to the (M+1)th channel based on the parameter generation network to obtain the compression information corresponding to the (M+1)th channel.

Exemplarily, assuming that the channel numbers contained in each of the predetermined groupings are channel 1 to channel 16, channel 17 to channel 32, and channel 33 to channel 64 in turn, in response to determining the compression information corresponding to the channel 20 (i.e., the 20th channel), the channel values of channel 17 to channel 19 may be input into the spatial context model to obtain the second spatial redundancy feature corresponding to the channel 20 that is output by the spatial context model; and the second feature maps corresponding to the first predetermined grouping (i.e., channel 1 to channel 16) may be input into the channel autoregressive model to obtain the second channel redundancy feature corresponding to the channel 20 that is output by the channel autoregressive model, and the compression information corresponding to the channel 20 may be determined based on the second channel redundancy feature and the second spatial redundancy feature corresponding to the channel 20.

The step S7013 includes: decoding first compressed data in the target compression result based on the compression information corresponding to the (M+1)th channel to determine the value of the (M+1)th channel; wherein the values of the channels belonging to a same predetermined grouping constitute one second feature map.

Specifically, in response to determining the value of the (M+1)th channel, the compression information corresponding to the (M+1)th channel and the first compressed data may be input into a second entropy decoding model to determine the value of the (M+1)th channel.

Here the second entropy decoding model and the second entropy encoding model may be probability models in the same form, for example, the second entropy encoding model and the second entropy decoding model may both be a Gaussian distribution model. The second entropy decoding model is configured to decode the first compressed data obtained after being processed by the second entropy encoding model to obtain the values of the channels.

The step S702 includes: splicing channels of the plurality of the second feature maps to obtain a first feature map.

The step S703 includes: performing second decoding on the first feature map to obtain the target image.

Here, in response to performing the second decoding on the first feature map, the first feature map may be input into a trained target neural network to obtain the target image corresponding to the first feature map output by the target neural network. The target neural network is a neural network that allows for deep learning, e.g., a convolutional neural network.

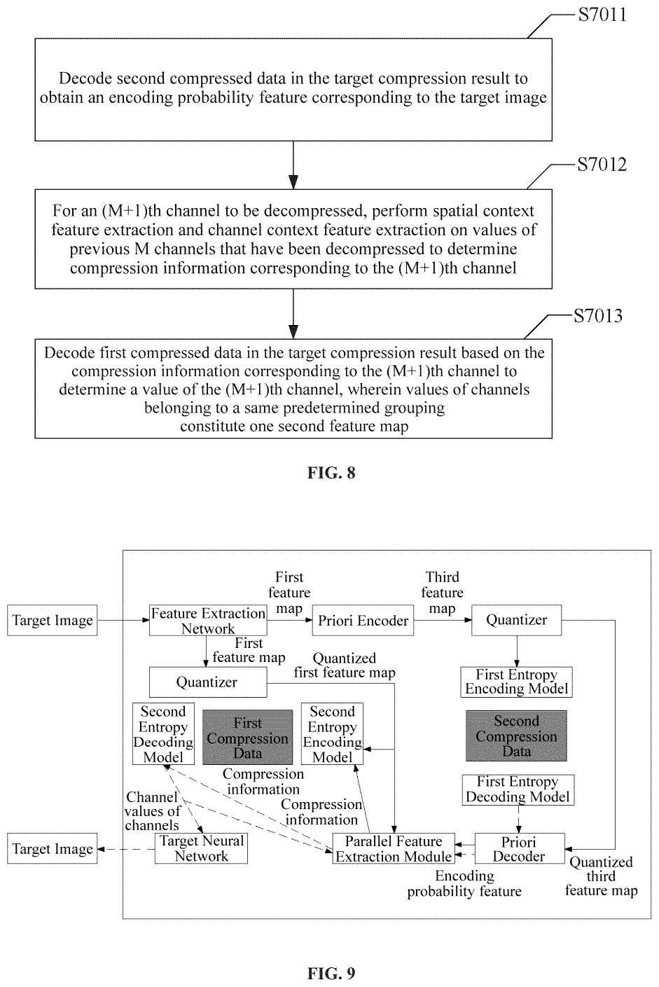

The above-mentioned image compression method and image decompression method will be described as a whole with reference to specific implementations. Referring to FIG. 9, there is shown an overall flowchart of an image encoding and decoding method provided in an embodiment of the present disclosure. In this flowchart, the parts related to image encoding (i.e., performing image compression) are denoted by solid lines, and the parts related to image decoding (i.e., performing image decompression) are denoted by dotted lines.

In the first place, the process of image encoding is described. The process of image encoding mainly comprises the following steps.

In step 1, a target image, after acquired, is input into a feature extraction network to obtain a first feature map corresponding to the target image.

In step 2, in one aspect, the first feature map is input into a quantizer for quantization processing; and in another aspect, after inputting the first feature map into a priori encoder for encoding, a third feature map corresponding to the target image is obtained, and the third feature map is quantized and then input into a priori decoder to obtain an encoding probability feature.

In step 3, the quantized first feature map and the encoding probability feature are input into a parallel feature extraction module to obtain compression information corresponding to the target image.

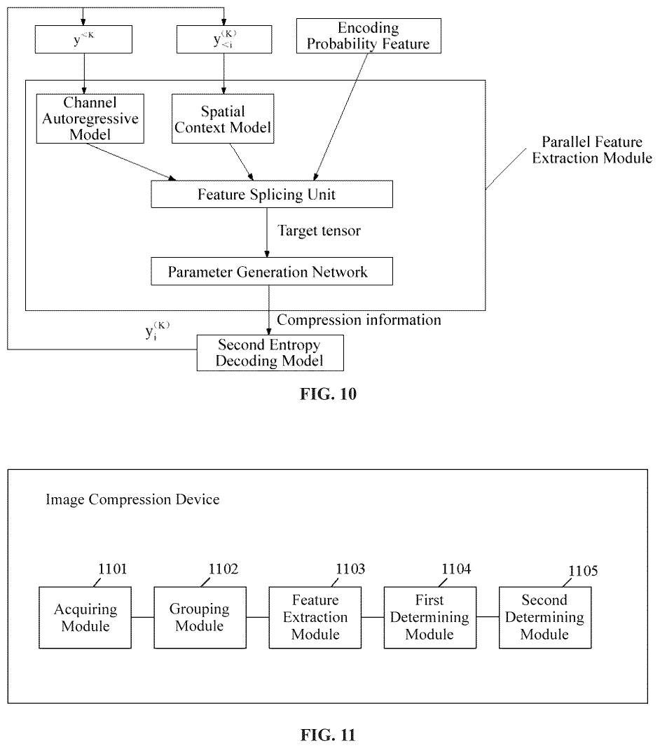

The parallel feature extraction module is configured to extract the channel redundancy features and spatial redundancy features of channels in the second feature map in parallel. Specifically, the structure of the parallel feature extraction module is as shown in FIG. 10, including a channel autoregressive model, a spatial context model, a feature splicing unit, and a parameter generation network. The above embodiments are referred to for the specific process of obtaining the compression information, which will not be repeated here.

In step 4, after obtaining the compression information, the compression information and the quantized first feature map are input into a second entropy encoding model to obtain the first compressed data corresponding to the target image. At the same time, the quantized third feature map is input into a first entropy encoding model to obtain the second compressed data corresponding to the target image.

After the first compressed data and the second compressed data are obtained, the process of compressing the target image is thus completed.

Next, the process of image decoding is described. The process of image decoding mainly comprises the following steps.

In step 1, firstly, the second compressed data is subjected to the entropy decoding in the first entropy decoding model to obtain a fourth feature map.

In step 2, the fourth feature map is input into a priori decoder to obtain an encoding probability feature.

In step 3, at the first decoding, the encoding probability feature is input into a parallel feature extraction model for cyclic decoding to obtain the channel values of respective channels.

Specifically, in FIG. 10, y^{<K} represents all of the second feature maps (i.e., first K−1 groups of channels) preceding the K-th second feature map (i.e., the K-th group of channels); y_{<i}^{(K)} represents channel values of channels preceding the i-th channel in the K-th feature map; y_{<i}^{(K)} represents the channel value of the i-th channel in the K-th feature map. In the process of image decoding, the second entropy decoding model may determine the channel value yᵢ^{(K)} of each channel respectively in turn based on the input compression information and further determine y_{<i}^{(K)} and y^{<K}, where K is a positive integer.

In step 4, after the channel value of each of the channels is determined, the first feature map may be determined, and then the first feature map is input into a target neural network for decoding to obtain the target image.

Specifically, the descriptions of the embodiments described above may be referred to for the example of performing cyclic decoding in the parallel feature extraction network, which will not be repeated here.

A person skilled in the art may understand that, in the foregoing method according to specific embodiments, the order of describing the steps does not means a strict order of execution that imposes any limitation on the implementation process. Rather, a specific order of execution of the steps should depend on the functions and possible inherent logics of the steps.

Based on the same inventive concept, an embodiment of the present disclosure further provides an image compression device corresponding to the image compression method. Since the principle of addressing problems by the device in the embodiment described herein is similar to that by the above image compression method in the embodiment described herein, the implementation of the method may be referred to for that of the device, and the repetitions will not be stated.

Referring to FIG. 11, there is shown a schematic diagram of the configuration of an image compression device provided in an embodiment of the present disclosure. The device comprises: an acquiring module 1101, a grouping module 1102, a feature extraction module 1103, a first determining module 1104, and a second determining module 1105; wherein
the acquiring module 1101 is configured to: acquire a target image, and perform feature extraction on the target image to obtain a first feature map comprising a plurality of channels;
the grouping module 1102 is configured to group the channels of the first feature map to obtain a plurality of second feature maps;
the feature extraction module 1103 is configured to: perform spatial context feature extraction on the second feature maps to determine first spatial redundancy features corresponding to the second feature maps, and perform channel context feature extraction on the second feature maps to determine first channel redundancy features corresponding to the second feature maps;
the first determining module 1104 is configured to determine compression information corresponding to each of the second feature maps respectively based on a first spatial redundancy feature and a first channel redundancy feature corresponding to each of the second feature maps; and
the second determining module 1105 is configured to: determine first compressed data corresponding to the target image based on the compression information corresponding to each of the second feature maps, and perform deep compression processing based on the first feature map to determine second compressed data corresponding to the target image, where the first compressed data and the second compressed data constitute a target compression result corresponding to the target image.

In a possible implementation, after the first feature map is obtained, the acquiring module 1101 is further configured to:
perform quantization on the first feature map, and
the grouping module 1102, in response to grouping the channels of the first feature map to obtain the plurality of second feature maps, is configured to:
group the channels of the quantized first feature map based on the predetermined number of target channels to obtain a plurality of predetermined groupings, where channel values of one predetermined grouping constitute one second feature map, and the number of channels contained in each of the second feature maps are not identical.

In a possible implementation, the feature extraction module 1103, in response to performing the spatial context feature extraction on the second feature maps to determine the first spatial redundancy features corresponding to the second feature maps, is configured to: for any one of the second feature maps, determine a first spatial redundancy feature corresponding to each of the channels of the second feature map respectively in turn based on a spatial context model, where the first spatial redundancy feature corresponding to each of the channels of the second feature map together constitute the first spatial redundancy feature corresponding to the second feature map.

In a possible implementation, the feature extraction module 1103 is further configured to determine the first spatial redundancy features corresponding to the channels of the second feature map by the following step:
for any one channel of any one of the second feature maps, inputting channel values of channels preceding the channel into the spatial context model to determine the first spatial redundancy feature corresponding to the channel; and a first spatial redundancy feature corresponding to a first channel of any one of the second feature maps being null.

In a possible implementation, the feature extraction module 1103, in response to performing channel context feature extraction on the second feature maps to determine the first channel redundancy features corresponding to the second feature maps, is configured to:
for an (N+1)th second feature map, input previous N second feature maps into a channel autoregressive model to determine a first channel redundancy feature corresponding to the (N+1)th second feature map; wherein N is a positive integer, the first channel redundancy feature of the first second feature map is null, and a channel number of the channel of the (N+1)th second feature map in the first feature map is greater than the channel numbers of the previous N second feature maps.

In a possible implementation, the first determining module 1104, in response to determining the compression information corresponding to each of the second feature maps respectively based on the first spatial redundancy feature and the first channel redundancy feature corresponding to each of the second feature maps, is configured to:
determine an encoding probability feature corresponding to the target image; and
for any one of the second feature maps, determine the compression information corresponding to the second feature map based on the first spatial redundancy feature and the first channel redundancy feature corresponding to the second feature map and the encoding probability feature.

In a possible implementation, the first determining module 1104, in response to determining the encoding probability feature corresponding to the target image, is configured to:
encode the first feature map based on a priori encoder to obtain a third feature map corresponding to the target image; and
perform quantization on the third feature map, and decode the quantized third feature map based on a priori decoder to obtain the encoding probability feature.

In a possible implementation, the second determining module 1105, in response to performing deep compression processing based on the first feature map to determine the second compressed data corresponding to the target image, is configured to:
input, after obtaining the quantized third feature map based on the first feature map, the quantized third feature map into a first entropy encoding model to obtain the second compressed data output by the first entropy encoding model.

In a possible implementation, the first determining module 1104, when determining, for any one of the second feature maps, the compression information corresponding to the second feature map based on the first spatial redundancy feature and the first channel redundancy feature corresponding to the second feature map and the encoding probability feature, is configured to:
splice the first spatial redundancy feature, the first channel redundancy feature, and the encoding probability feature to obtain a spliced target tensor; and
perform feature extraction on the target tensor based on a parameter generation network to generate the compression information corresponding to the second feature map.

In a possible implementation, the second determining module 1105, in response to determining the first compressed data corresponding to the target image based on the compression information corresponding to each of the second feature maps, is configured to:
input the first feature map and the compression information corresponding to each of the second feature maps into a second entropy encoding model to obtain the first compressed data output by the second entropy encoding model.

By grouping the first feature map obtained after performing the feature extraction to obtain a plurality of second feature maps, and by performing the spatial context feature extraction and channel context feature extraction on the second feature maps, the image compression device provided in an embodiment of the present disclosure may perform both the spatial redundancy compression and channel redundancy compression on the second feature maps, thereby improving the compression encoding rate of the target image. Thereafter, the image is compressed based on the first spatial redundancy features and the first channel redundancy features, which reduces the size of the target compression result corresponding to the target image.

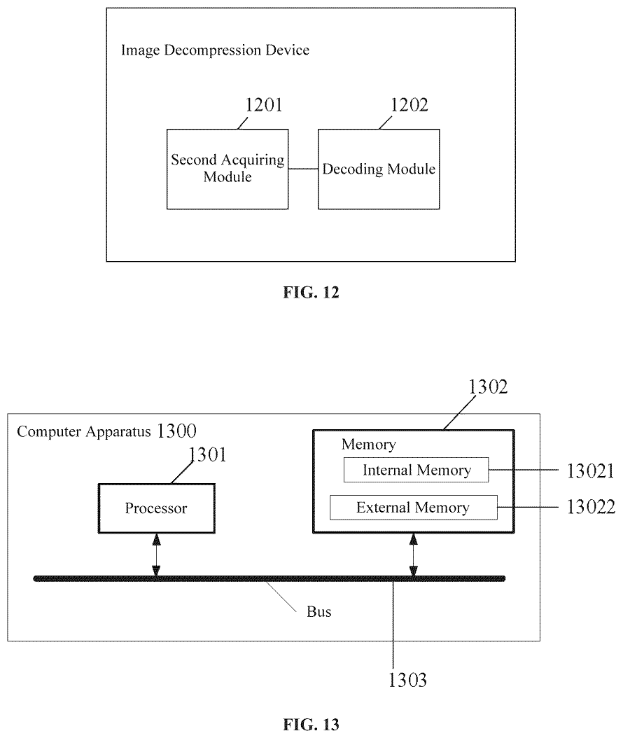

Referring to FIG. 12, there is shown a schematic diagram of the configuration of an image decompression device provided in an embodiment of the present disclosure. The device comprises: a second acquiring module 1201 and a decoding module 1202; wherein
the second acquiring module 1201 is configured to acquire a target compression result that is compressed based on any one of the methods according to the embodiments of the present disclosure; and the decoding module 1202 is configured to decode the target compression result to obtain the target image.

In a possible implementation, the decoding module 1202, in response to decoding the target compression result to obtain the target image, is configured to:
perform first decoding on the target compression result to obtain a plurality of second feature maps;
splice channels of the plurality of the second feature maps to obtain a first feature map; and
perform second decoding on the first feature map to obtain the target image.

In a possible implementation, the decoding module 1202, in response to performing first decoding on the target compression result to obtain the plurality of second feature maps, is configured to:
decode second compressed data in the target compression result to obtain an encoding probability feature corresponding to the target image;
for an (M+1)th channel to be decompressed, perform spatial context feature extraction and channel context feature extraction on values of previous M channels that have been decompressed to determine compression information corresponding to the (M+1)th channel; wherein compression information of a first channel is determined based on the encoding probability feature; and
decode first compressed data in the target compression result based on the compression information corresponding to the (M+1)th channel to determine a value of the (M+1)th channel; wherein the values of the channels belonging to a same predetermined grouping together constitute one second feature map.

In a possible implementation, the decoding module 1202, in response to decoding second compressed data in the target compression result to obtain the encoding probability feature corresponding to the target image, is configured to:
input the second compressed data into a first entropy decoding model to obtain a fourth feature map output by the first entropy decoding model; and
decode the fourth feature map to obtain the encoding probability feature.

In a possible implementation, the (M+1)th channel belongs to a K-th predetermined grouping, wherein K is a positive integer;
the decoding module 1202, when performing, for the (M+1)th channel to be decompressed, the spatial context feature extraction and the channel context feature extraction on the values of the first M channels that have been decompressed to determine the compression information corresponding to the (M+1)th channel, is configured to:
perform the spatial context feature extraction on values of channels with channel numbers less than M+1 in the K-th predetermined grouping to determine a second spatial redundancy feature corresponding to the (M+1)th channel; and perform the channel context feature extraction on the second feature maps corresponding to previous (K−1)th predetermined groupings to determine a second channel redundancy feature corresponding to the (M+1)th channel; and
determine the compression information corresponding to the (M+1)th channel based on the second spatial redundancy feature, the second channel redundancy feature, and the encoding probability feature.

In a possible implementation, the decoding module 1202, in response to decoding the first compressed data in the target compression result based on the compression information corresponding to the (M+1)th channel to determine the value of the (M+1)th channel, is configured to:
input the compression information corresponding to the (M+1)th channel and the first compressed data into a second entropy decoding model to determine the value of the (M+1)th channel.

Relevant descriptions in the above method embodiments may be referred to for the processing steps of the modules in the device and the interactive steps between the modules, which will not be detailed here.

Based on the same technical concept, an embodiment of the present disclosure further provides a computer apparatus. Referring to FIG. 13, there is shown a structural diagram of a computer apparatus 1300 provided in an embodiment of the present disclosure, comprising a processor 1301, a memory 1302, and a bus 1303. Of these, the memory 1302 is configured to store executive instructions, and includes an internal memory 13021 and an external memory 13022. The internal memory 13021 here is also referred to as an internal storage configured to temporarily store computing data in the processor 1301, and data exchanged with the external memory 13022 such as a hard disk. The processor 1301 exchanges data with the external memory 13022 through the internal memory 13021. When the computer apparatus 1300 runs, the processor 1301 communicates with the memory 1302 via the bus 1303, such that the processor 1301 is executing the following instructions:
acquiring a target image, and performing feature extraction on the target image to obtain a first feature map comprising a plurality of channels;
grouping the channels of the first feature map to obtain a plurality of second feature maps;
performing spatial context feature extraction on the second feature maps to determine first spatial redundancy features corresponding to the second feature maps, and performing channel context feature extraction on the second feature maps to determine first channel redundancy features corresponding to the second feature maps;
determining compression information corresponding to each of the second feature maps respectively based on a first spatial redundancy feature and a first channel redundancy feature corresponding to each of the second feature maps; and
determining first compressed data corresponding to the target image based on the compression information corresponding to each of the second feature maps, and performing deep compression processing based on the first feature map to determine second compressed data corresponding to the target image, the first compressed data and the second compressed data constituting a target compression result corresponding to the target image; or
the processor 1301 is executing the following instructions:
acquiring a target compression result that is compressed based on any one of the methods provided in the embodiments of the present disclosure; and
decoding the target compression result to obtain the target image.

According to an embodiment of the present disclosure, there is further provided a computer readable storage medium having a computer program stored thereon, wherein the computer program, when executed by a processor, causes steps of the image compression method in the above method embodiments to be executed. The storage medium may be a transitory or non-transitory computer readable storage medium.

According to an embodiment of the present disclosure, there is further provided a computer program product that hosts program codes including instructions that may be configured to execute steps of the image compression method in the above method embodiments. The above method embodiments may be referred to for the details, which will not be repeated here.

According to an embodiment of the present disclosure, there is further provided a computer program product, comprising computer readable codes, or a non-transitory computer readable storage medium hosting the computer readable codes, wherein when the computer readable codes runs in a processor of an electronic apparatus, the processor of the electronic apparatus executes the methods described above.

The above computer program product may be specifically implemented by means of hardware, software or a combination thereof. In an optional embodiment, the computer program product is specifically embodied as a computer storage medium. In another optional embodiment, the computer program product is specifically embodied as a software product, such as Software Development Kit (SDK).

It will be clear to a person skilled in the art that for the convenience and brevity of descriptions, the corresponding procedures of the foregoing method embodiments may be referred to for the specific working procedures of the systems and devices described above, which will not be repeated here. In the several embodiments provided herein, it shall be appreciated that the systems, devices, and methods disclosed here may be implemented in other ways. The device embodiments described above are only exemplary. For example, the units are only divided according to their logic functions, and they may be divided in another way when actually implemented. For another example, a plurality of units or components may be combined or integrated into another system, or some features may be ignored or not implemented. Additionally, the mutual coupling or direct coupling or communication connection shown or discussed may be indirect coupling or communication connection via some communication interfaces, devices or units, or may be electrical, mechanical or in other forms.

The units illustrated as separate components may or may not be physically separated. The components displayed as units may or may not be physical units, that is, they may be located in one place, or may be distributed over a plurality of network units. Part or all of the units may be selected as actually required to fulfill the purpose of the solution of the embodiment.

In addition, the functional units in various embodiments described herein may be integrated in one processing unit, or each of the units may exist alone physically, or two or more units may be integrated in a single unit.

The functions, if implemented in the form of functional units of software and sold or used as stand-alone products, may be stored in non-transitory computer readable storage medium executable by a processor. Based on this understanding, the technical solution of the present disclosure in essence or the part contributing to the existing technologies or the part of this technical solution may be embodied in the form of a software product. This computer software product is stored in a storage medium and includes several instructions for causing a computer apparatus (which may be a personal computer, a server, or a network apparatus, etc.) to execute all or part of the steps of the methods described in various embodiments of the present disclosure. The above-mentioned storage medium includes various media that may store program codes, such as a USB flash disk, a mobile hard disk, a Read-Only Memory (ROM), a Random Access Memory (RAM), a magnetic disk or an optical disk.

Finally, it should be noted that the embodiments described above are merely specific embodiments of the present disclosure used to illustrate, not limit, the technical solutions described herein, and the scope of protection of the present disclosure is not limited thereto. Although the present disclosure has been described in detail with reference to the foregoing embodiments, it should be understood by a person skilled in the art that any skilled person familiar with this technical field may still modify the technical solutions described in the preceding embodiments within the technical scope disclosed herein, or may readily conceive of variations thereof, or make equivalent substitutions for part of the technical features thereof. Moreover, these modifications, variations or substitutions do not depart the essence of the corresponding technical solution from the spirits and scope of the technical solutions of the embodiments described herein, and shall all be encompassed within the scope of protection for the present disclosure. Therefore, the scope of protection for the present disclosure shall be subject to that for the claims.

What is claimed is:

1. An image compression method, comprising:
acquiring a target image;
performing feature extraction on the target image to obtain a first feature map comprising a plurality of channels;
grouping the channels of the first feature map to obtain a plurality of second feature maps;
performing spatial context feature extraction on the second feature maps to determine first spatial redundancy features corresponding to the second feature maps;
performing channel context feature extraction on the second feature maps to determine first channel redundancy features corresponding to the second feature maps;
determining compression information corresponding to each of the plurality of the second feature maps respectively based on a first spatial redundancy feature and a first channel redundancy feature corresponding to each of the plurality of the second feature maps;
determining first compressed data corresponding to the target image based on the compression information corresponding to each of the plurality of the second feature maps;
performing deep compression processing based on the first feature map; and
determining second compressed data corresponding to the target image, the first compressed data and the second compressed data constituting a target compression result corresponding to the target image.

2. The method according to claim 1, wherein after obtaining the first feature map, the method further comprises:
performing quantization on the first feature map; and
wherein grouping the channels of the first feature map to obtain the plurality of the second feature maps comprises:
grouping the channels of the first feature map that has been quantized based on a predetermined number of target channels to obtain a plurality of predetermined groupings, channel values in each predetermined grouping constituting each of the second feature maps, wherein numbers of channels included in different second feature maps are not identical.

3. The method according to claim 1, wherein performing the spatial context feature extraction on the second feature maps to determine the first spatial redundancy features corresponding to the second feature maps comprises:
determining, for any one of the second feature maps, the first spatial redundancy features respectively corresponding to each of the channels of the second feature map based on a spatial context model, the first spatial redundancy features corresponding to each of the channels of the second feature map constituting the first spatial redundancy features corresponding to the second feature map.

4. The method according to claim 3, wherein the method further comprises determining the first spatial redundancy features corresponding to each of the channels of the second feature map by:
inputting, for any one channel of any one of the second feature maps, a channel value of a preceding channel into the spatial context model to determine a first spatial redundancy feature corresponding to the one channel;
wherein a first spatial redundancy feature corresponding to a first channel of the second feature maps is null.

5. The method according to claim 1, wherein performing the channel context feature extraction on the second feature maps to determine the first channel redundancy features corresponding to the second feature maps comprises:
for an (N+1)th second feature map, inputting previous N second feature maps into a channel autoregressive model to determine a first channel redundancy feature corresponding to the (N+1)th second feature map, wherein N is a positive integer, a first channel redundancy feature of a first second feature map is null, and a channel number of each channel of the (N+1)th second feature map in the first feature map is greater than channel numbers of the previous N second feature maps.

6. The method according to claim 1, wherein determining the compression information corresponding to each of the plurality of the second feature maps respectively based on the first spatial redundancy feature and the first channel redundancy feature corresponding to each of the plurality of the second feature maps comprises:
determining an encoding probability feature corresponding to the target image; and
determining, for any one of the second feature maps, compression information corresponding to the second feature map based on a first spatial redundancy feature and a first channel redundancy feature corresponding to the second feature map and the encoding probability feature.

7. The method according to claim 6, wherein determining the encoding probability feature corresponding to the target image comprises:
encoding the first feature map based on a priori encoder to obtain a third feature map corresponding to the target image; and
performing quantization on the third feature map; and
decoding a quantized third feature map based on a priori decoder to obtain the encoding probability feature.

8. The method according to claim 7, wherein performing the deep compression processing based on the first feature map to determine the second compressed data corresponding to the target image comprises:
after obtaining the quantized third feature map based on the first feature map, inputting the quantized third feature map into a first entropy encoding model to obtain the second compressed data output by the first entropy encoding model.

9. The method according to claim 6, wherein determining, for any one of the second feature maps, the compression information corresponding to the second feature map based on the first spatial redundancy feature and the first channel redundancy feature corresponding to the second feature map and the encoding probability feature comprises:
splicing the first spatial redundancy feature, the first channel redundancy feature, and the encoding probability feature to obtain a spliced target tensor; and
performing feature extraction on the spliced target tensor based on a parameter generation network to generate the compression information corresponding to the second feature map.

10. The method according to claim 1, wherein determining the first compressed data corresponding to the target image based on the compression information corresponding to each of the plurality of the second feature maps comprises:
inputting the first feature map and the compression information corresponding to each of the plurality of the second feature maps into a second entropy encoding model to obtain the first compressed data output by the second entropy encoding model.

11. An image decompression method, comprising:
acquiring a target image;
performing feature extraction on the target image to obtain a first feature map comprising a plurality of channels;
grouping the channels of the first feature map to obtain a plurality of second feature maps;
performing spatial context feature extraction on the second feature maps to determine first spatial redundancy features corresponding to the second feature maps;
performing channel context feature extraction on the second feature maps to determine first channel redundancy features corresponding to the second feature maps;
determining compression information corresponding to each of the plurality of the second feature maps respectively based on a first spatial redundancy feature and a first channel redundancy feature corresponding to each of the plurality of the second feature maps; and
determining first compressed data corresponding to the target image based on the compression information corresponding to each of the plurality of the second feature maps;
performing deep compression processing based on the first feature map;
determining second compressed data corresponding to the target image, the first compressed data and the second compressed data constituting a target compression result corresponding to the target image; and
decoding the target compression result to obtain a target image.

12. The method according to claim 11, wherein decoding the target compression result to obtain the target image comprises:
performing first decoding on the target compression result to obtain the plurality of second feature maps;
splicing the channels of the plurality of the second feature maps to obtain the first feature map; and
performing second decoding on the first feature map to obtain the target image.

13. The method according to claim 12, wherein performing the first decoding on the target compression result to obtain the plurality of the second feature maps comprises:
decoding the second compressed data in the target compression result to obtain an encoding probability feature corresponding to the target image;
performing, for an (M+1)th channel to be decompressed, spatial context feature extraction and channel context feature extraction on values of previous M channels that have been decompressed to determine compression information corresponding to the (M+1)th channel, wherein compression information of a first channel is determined based on the encoding probability feature; and
decoding the first compressed data in the target compression result based on the compression information corresponding to the (M+1)th channel to determine a value of the (M+1)th channel, wherein values of each channel belonging to a same predetermined grouping constitute a second feature map respectively.

14. The method according to claim 13, wherein decoding the second compressed data in the target compression result to obtain the encoding probability feature corresponding to the target image comprises:
inputting the second compressed data into a first entropy decoding model to obtain a fourth feature map output by the first entropy decoding model; and
decoding the fourth feature map to obtain the encoding probability feature.

15. The method according to claim 13, wherein the (M+1)th channel belongs to a K-th predetermined grouping, and K is a positive integer; and
performing, for the (M+1)th channel to be decompressed, the spatial context feature extraction and the channel context feature extraction on the values of the previous M channels that have been decompressed to determine the compression information corresponding to the (M+1)th channel comprises:
performing the spatial context feature extraction on values of channels with channel numbers less than M+1 in the K-th predetermined grouping to determine a second spatial redundancy feature corresponding to the (M+1)th channel; and performing the channel context feature extraction on second feature maps corresponding to previous (K−1)th predetermined groupings to determine a second channel redundancy feature corresponding to the (M+1)th channel; and
determining the compression information corresponding to the (M+1)th channel based on the second spatial redundancy feature, the second channel redundancy feature, and the encoding probability feature.

16. The method according to claim 13, wherein decoding the first compressed data in the target compression result based on the compression information corresponding to the (M+1)th channel to determine the value of the (M+1)th channel comprises:
inputting the compression information corresponding to the (M+1)th channel and the first compressed data into a second entropy decoding model to determine the value of the (M+1)th channel.

17. A computer apparatus, comprising:
at least one processor,
at least one memory, and
at least one bus, wherein the least one memory stores machine readable instructions executable by the least one processor, when the computer apparatus runs, the least one processor communicates with the least one memory via the least one bus, and the machine readable instructions, when executed by the least one processor, cause execution of image compression operations comprising:
acquiring a target image;
performing feature extraction on the target image to obtain a first feature map comprising a plurality of channels;
grouping the channels of the first feature map to obtain a plurality of second feature maps;
performing spatial context feature extraction on the second feature maps to determine first spatial redundancy features corresponding to the second feature maps;
performing channel context feature extraction on the second feature maps to determine first channel redundancy features corresponding to the second feature maps;
determining compression information corresponding to each of the plurality of the second feature maps respectively based on a first spatial redundancy feature and a first channel redundancy feature corresponding to each of the plurality of the second feature maps; and
determining first compressed data corresponding to the target image based on the compression information corresponding to each of the plurality of the second feature maps;
performing deep compression processing based on the first feature map; determining second compressed data corresponding to the target image, the first compressed data and the second compressed data constituting a target compression result corresponding to the target image;
or, cause execution of image decompression operations comprising:
acquiring a target image;
performing feature extraction on the target image to obtain a first feature map comprising a plurality of channels;
grouping the channels of the first feature map to obtain a plurality of second feature maps;
performing spatial context feature extraction on the second feature maps to determine first spatial redundancy features corresponding to the second feature maps;
performing channel context feature extraction on the second feature maps to determine first channel redundancy features corresponding to the second feature maps;
determining compression information corresponding to each of the plurality of the second feature maps respectively based on a first spatial redundancy feature and a first channel redundancy feature corresponding to each of the plurality of the second feature maps;
determining first compressed data corresponding to the target image based on the compression information corresponding to each of the plurality of the second feature maps;
performing deep compression processing based on the first feature map;
determining second compressed data corresponding to the target image, the first compressed data and the second compressed data constituting a target compression result corresponding to the target image; and
decoding the target compression result to obtain a target image.
